(19) United States
(12) Patent Application Publication
(10) Pub. No.: US 2026/0098607 A1
(43) Pub. Date: Apr. 9, 2026

(54) PRESSURE VESSEL

(71) Applicant: TOYOTA JIDOSHA KABUSHIKI KAISHA, Toyota-shi (JP)

(72) Inventors: Osamu SAWAI, Okazaki-shi (JP); Yuki KAI, Nagoya-shi (JP)

(73) Assignee: TOYOTA JIDOSHA KABUSHIKI KAISHA, Toyota-shi (JP)

(21) Appl. No.: 19/337,131

(22) Filed: Sep. 23, 2025

(30) Foreign Application Priority Data
Oct. 8, 2024 (JP) 2024-176689

(51) Int. Cl. F17C 1/02

(52) U.S. Cl. CPC F17C 1/02; F17C 2201/0104; F17C 2205/0302; F17C 2221/012; F17C 2270/0168

(57) ABSTRACT

A pressure vessel that is able to store fluid includes a plurality of main body portions provided with a space inside, and a connecting portion to which one ends of each of the main body portions are connected respectively, and communicating with the main body portions to one another. A cross section perpendicular to a longitudinal direction of the main body portion has a substantially quadrilateral shape. The main body portion includes a reinforcing member that connects a pair of opposing surfaces within the space.

### CROSS-REFERENCE TO RELATED APPLICATION

This application claims priority to Japanese Patent Application No. 2024-176689 filed on Oct. 8, 2024. The disclosure of the above-identified application, including the specification, drawings, and claims, is incorporated by reference herein in its entirety.

### BACKGROUND

### 1. Technical Field

The technique disclosed in the present specification relates to a pressure vessel.

### 2. Description of Related Art

Japanese Unexamined Patent Application Publication No. 2024-3069 (JP 2024-3069 A) discloses a tank unit disposed on a transport vehicle. The tank unit includes a plurality of cylindrical tanks that stores fuel gas and connecting portions that connect the tanks.

### SUMMARY

Conventionally, since tanks have been cylindrical in shape, it is difficult to say that the volume required to store fluid is efficiently secured.

The present specification discloses a pressure vessel that is able to store fluid. A pressure vessel includes a plurality of main body portions provided with a space inside, and a connecting portion to which one ends of each of the main body portions are connected respectively, and communicating with the main body portions to one another. A cross-section perpendicular to a longitudinal direction of the main body portion has a substantially quadrilateral shape.

According to the configuration, the cross section of the main body portion of the pressure vessel that is perpendicular to the longitudinal direction has the substantially quadrilateral shape. Therefore, compared to the conventional case in which the cross section is circular, a larger volume is able to be secured.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view showing a pressure vessel;

FIG. 2 is a cross-sectional view taken along line II-II of FIG. 1;

FIG. 3 is a sectional view taken along line III-III of FIG. 1;

FIG. 4 is an enlarged sectional view showing the vicinity of one end of a main body portion to which a base is attached;

FIG. 5 shows a modified pressure vessel housed in an underfloor space of a vehicle; and

FIG. 6 shows a conventional pressure vessel housed in the underfloor space of the vehicle.

### DETAILED DESCRIPTION OF EMBODIMENTS

The present embodiment will be described with reference to the drawings. Each figure is merely an example, and the present embodiment is not limited to the contents shown in the figures. Further, since each figure is merely an example, some parts may be omitted.

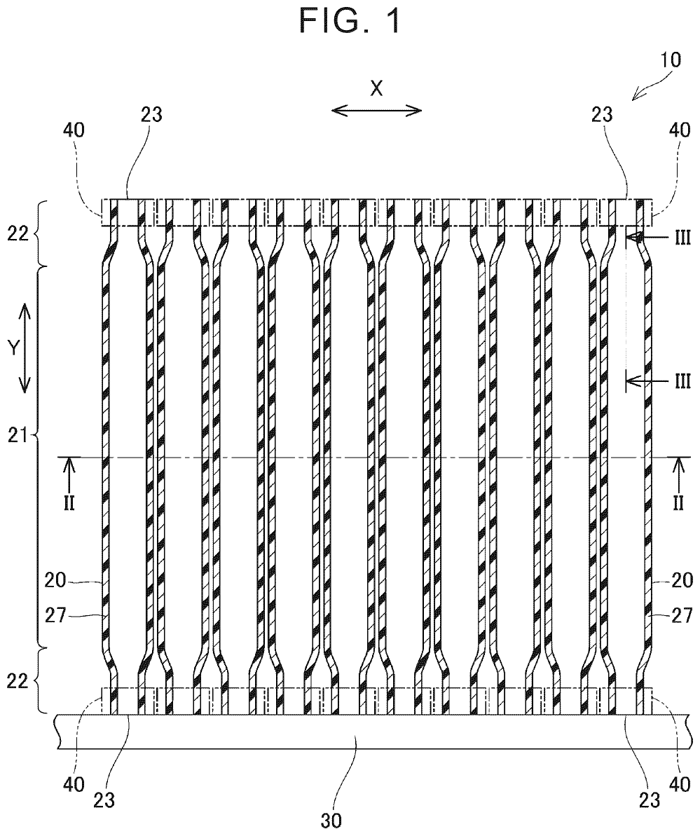

FIG. 1 is a simplified sectional view of a pressure vessel 10 according to the present embodiment. The pressure vessel 10 is able to store fluid. The fluid is, for example, a fuel gas such as hydrogen. In each figure, X and Y directions are appropriately indicated for ease of explanation. The X direction and the Y direction are orthogonal to each other. The pressure vessel 10 includes a plurality of main body portions 20 provided with a space inside, and a connecting portion 30 to which one ends of each of the main body portions 20 are connected respectively, and communicating with the main body portions 20 to one another. The connecting portion 30 is a flow path for allowing fluid to flow. The main body portions 20 are in communication with each other via the connecting portion 30. Further, the fluid stored in each of the main body portions 20 is supplied to the outside of the pressure vessel 10 via the connecting portion 30. In FIG. 1, a section of the main body portion 20 is shown.

According to FIG. 1, the main body portion 20 is elongated in the Y direction, and both ends in the Y direction are provided with an opening 23. According to FIG. 1, the Y direction corresponds to the longitudinal direction of the main body portion 20. Each of the main body portions 20 has the opening 23 at one end in the Y direction connected to the connecting portion 30 in the same manner. According to FIG. 1, the main body portions 20 are arranged side by side along the X direction (one direction). Further, the main body portions 20 are arranged at substantially the same position in the Y direction. However, the main body portions 20 may have non-uniform lengths in the Y direction, for example.

The main body portion 20 includes a body portion 21 provided with a substantially uniformly shaped cross section perpendicular to the longitudinal direction, and tapered portions 22 that are both ends of the body portion 21 in the longitudinal direction. The tapered portion 22 narrows the cross-sectional area perpendicular to the longitudinal direction from the body portion 21 toward the opening 23 gradually or in a stepwise manner. Hereinafter, a cross section of the main body portion 20 perpendicular to the longitudinal direction will be referred to as a “first cross section”.

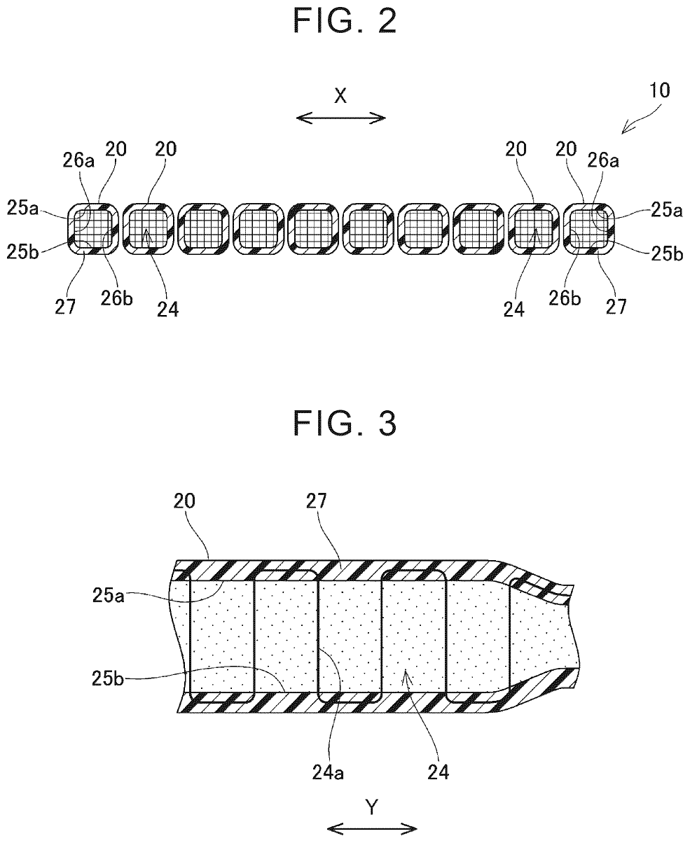

FIG. 2 is a sectional view taken along line II-II of FIG. 1. FIG. 2 shows the shape of the first cross sections of the main body portions 20. As shown in FIG. 2, the first cross section has a substantially quadrilateral shape. The term “substantially quadrilateral” refers to a shape including two pairs of opposing flat surfaces (a pair of surfaces 25a, 25b and a pair of surfaces 26a, 26b) and four corners connecting the four surfaces. In reality, the four corners of the first cross section are more accurately represented as curved corners than as corners at which the flat surfaces intersects at right angles. Further, the opposing flat surfaces that define the first cross section do not need to be strictly parallel, and each flat surface may be slightly curved.

FIG. 3 is a sectional view taken along line III-III of FIG. 1. The main body portion 20 includes a reinforcing member 24 that connects a pair of opposing surfaces within the space of the main body portion 20. FIG. 3 shows a wire 24a that connects the pair of opposing surfaces 25a, 25b of the main body portion 20 in a wavy shape. The wire 24a is made of carbon fiber reinforced plastics (CFRP), which is a composite material of carbon fiber and resin. In other words, the reinforcing member 24 includes one or more wires 24a extending in the longitudinal direction of the main body portion 20 while suturing between the opposing surfaces.

In FIG. 3, each of the black dots in the main body portion 20 indicates a section of the wire 24a. In FIG. 2, a plurality of lines is drawn in a grid line shape in the main body portion 20, and each of the lines also represents the wire 24a. That is, within the space of the main body portion 20, between the surfaces 25a, 25b and between the surfaces 26a, 26b are sutured by the wires 24a. The reinforcing member 24 includes a plurality of such wires 24a. In FIG. 1, the reinforcing member 24 is omitted.

An example of a method of manufacturing the pressure vessel 10 will be briefly described. A plurality of liners is prepared as hollow bodies that will be the base material of the main body portions 20. For example, the liner is made of a resin such as nylon. The liner is a hollow body having a shape corresponding to the main body portion 20. A wire is wound, for example in a mesh or spiral pattern, on the outer surface of such a liner by a winding machine. The winding machine is also called a braiding machine, braider, etc. The wire wound around the liner is also made of CFRP in which carbon fiber is impregnated with resin. By winding the wire by the winding machine, a fiber layer 27 made of CFRP is provided such that the fiber layer 27 covers the outer surface of the liner.

Simultaneously with the winding of the wire by the winding machine, the wire 24a is sewn onto the liner by a sewing machine. There are various ways to sew the wire 24a using the sewing machine, such as wave stitching and so-called sewing machine stitching in which an upper thread (wire 24a) and a lower thread (wire 24a) are tied together. By sewing the wire 24a with the sewing machine, the wire 24a penetrates the space inside the liner, and the reinforcing member 24 as shown in FIG. 3 is provided, for example.

The liner and the winding machine and sewing machine move relative to each other along the longitudinal direction of the liner. For example, the winding machine and the sewing machine are fixed in position while the liner moves along the longitudinal direction. As the liner moves in such a manner, the sewing machine sews the wire 24a and the winding machine winds the wire concurrently. This allows the main body portion 20 to be manufactured efficiently while the portions of the wire 24a other than the portion that penetrates the space inside the main body portion 20 are housed within the fiber layer 27 as shown in FIG. 3. The main body portions 20 thus manufactured are each then connected at one end to the connecting portion 30 to provide the pressure vessel 10 having the shape shown in FIG. 1.

Thus, according to the present embodiment, the first cross section of the pressure vessel 10 has the substantially quadrilateral shape. Therefore, a larger volume for storing fluid is able to be secured, compared to a conventional configuration in which the cross section perpendicular to the longitudinal direction of the pressure vessel is circular.

From the viewpoint of ensuring strength against fluid pressure, it can be said that the conventional circular cross section is superior to the substantially quadrilateral first cross section. However, in the present embodiment, the main body portion 20 is configured to include the reinforcing member 24 in which the opposing surfaces are connected to each other. This allows the main body portion 20 to ensure strength against fluid pressure even though the first cross section has the substantially quadrilateral shape.

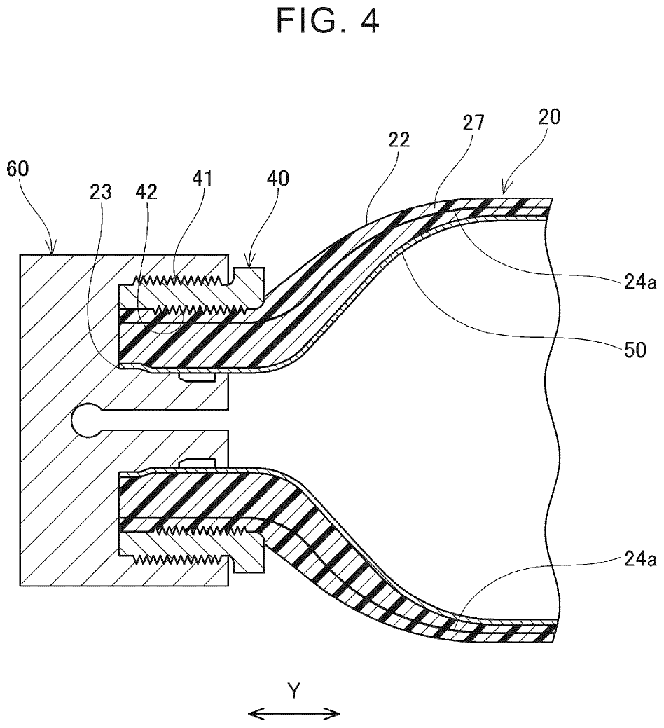

In the pressure vessel 10, a base 40 is provided at one end of the main body portion 20. In FIG. 1, as indicated by the two-dot chain line, the base 40 is attached to each of one end and the other end in the Y direction of each main body portion 20. FIG. 4 shows the vicinity of one end of the main body portion 20 to which the base 40 is attached, by an enlarged sectional view. According to FIG. 4, the main body portion 20 includes a liner 50 as an inner layer and the fiber layer 27 as an outer layer. For simplification, the liner 50 is not shown in any of the figures except FIG. 4. At one end of the main body portion 20, for example, a predetermined area (the area near the opening), close to the opening 23, of the tapered portion 22 is a tube of substantially the same diameter as the opening 23, and the base 40 is attached from the outside to the area near the opening. The base 40 is made of, for example, metal and has an annular shape.

A screw groove 41 for screwing in a fastening portion 60 is provided on the outer peripheral surface of the base 40. The fastening portion 60 will be described later. On the other hand, a plurality of locking claws 42 is provided on the inner peripheral surface of the base 40. When the base 40 is caulked to the area near the opening of the main body portion 20, the locking claws 42 bite into the outer peripheral surface of the fiber layer 27, thereby locking the base 40 to the main body portion 20.

The fastening portion 60 is fastened to the base 40 from the outside. In other words, the fastening portion 60 is fastened to the base 40 by a female screw portion provided on the inside of the fastening portion 60 being screwed into the screw groove 41 of the base 40. In the example of FIG. 4, a part of the fastening portion 60 enters the inside of the opening 23 and seals the opening 23. The fastening portion 60 may be a structure that allows communication between the opening 23 and another flow path, for example, the connecting portion 30.

As described above, the reinforcing member 24 includes the wire 24a extending in the longitudinal direction of the main body portion 20 while suturing between the opposing surfaces of the main body portion 20. Therefore, in the present embodiment, one end of the wire 24a may be fixed at a position away from the base 40 at one end of the main body portion 20 in which the base 40 is provided. In FIG. 4, the wires 24a are shown by solid lines in the fiber layer 27. The end of the wire 24a is embedded in the fiber layer 27 at a position where the locking claw 42 of the base 40 does not reach. In other words, when sewing the wire 24a with the sewing machine and winding the wire with the winding machine are performed concurrently as described above, one end of the wire 24a is embedded at one end of the main body portion 20 to which the base 40 will later be attached, namely at a predetermined position in the fiber layer 27 where the locking claw 42 does not reach. With this configuration, the locking claws 42 are restrained from coming into contact with the wire 24a within the fiber layer 27. Therefore, the biting of the locking claws 42 into the fiber layer 27 is not hindered, and the base 40 is firmly locked to the main body portion 20.

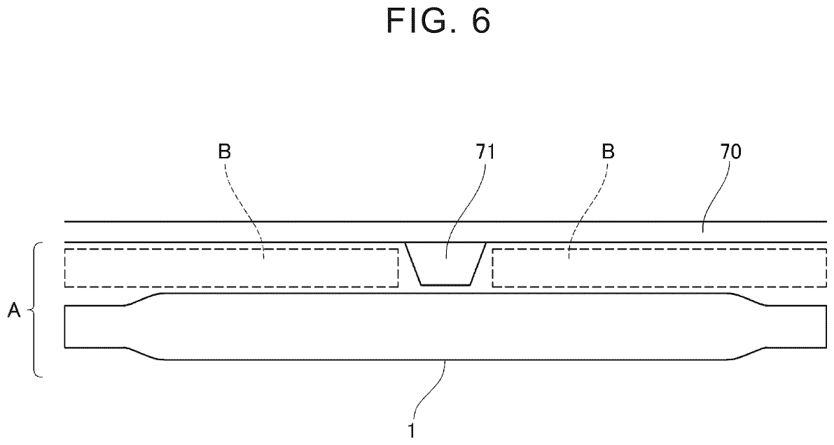

The pressure vessel 10 is housed, for example, in a space under the floor of a vehicle. The vehicle referred to here is, for example, a fuel cell electric vehicle or a hydrogen engine vehicle that uses hydrogen stored in the pressure vessel 10 as fuel to generate electricity or power. FIG. 6 shows a conventional pressure vessel 1 housed in an underfloor space A of the vehicle. The pressure vessel 1 is a typical cylindrical hydrogen tank including a circular cross section perpendicular to the longitudinal direction. A portion of the underfloor space A is demarcated by a body member 70 that separates the space above and below the floor of the vehicle.

The body member 70 includes a protruding portion 71 that protrudes downward at a predetermined position. The body member 70 and the protruding portion 71 correspond to a part of the vehicle body. The protruding portion 71 is, for example, a floor cross member for improving the rigidity of the vehicle body. As shown in FIG. 6, in the conventional technology, the presence of the protruding portion 71 generates a space B as a dead space between the body member 70 and the pressure vessel 1. In addition, the pressure vessel 1 is made compact so that it can be housed in the underfloor space A at a position lower than the protruding portion 71.

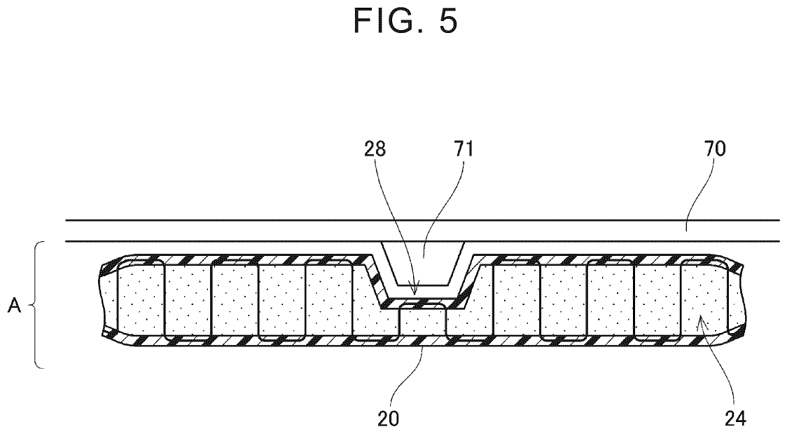

In consideration of such a situation, as a modification of the present embodiment, the main body portion 20 may have an uneven shape that follows the shape of the vehicle body that demarcates at least a portion of the space in which the pressure vessel 10 is housed. FIG. 5 shows the pressure vessel 10 according to the modification that is housed in the underfloor space A of the vehicle. In FIG. 5, only the main body portion 20 of the pressure vessel 10 is shown in a section viewed from the same point of view as FIG. 3.

As shown in FIG. 5, a recessed portion 28 for avoiding contact with the protruding portion 71 is provided on the upper surface of the main body portion 20, that is, at a position corresponding to the protruding portion 71 on the surface facing the body member 70. The recessed portion 28 is provided in the body portion 21. As will be understood from the above description, since the outer surface of the body portion 21 is flat, it is easier to provide the recessed portion 28 than in the conventional pressure vessel 1 having a cylindrical shape. The area of the body portion 21 that the recessed portion 28 is provided is naturally narrower in the first cross section than the area in which the recess 28 is not provided in the body portion 21.

The fact that the main body portion 20 includes the recessed portion 28 means that the main body portion 20 also includes a protruding portion when viewed from the recessed portion 28 as a reference. Therefore, the shape of the recessed portion 28 and its surroundings corresponds to a specific example of an uneven shape that follows the shape of the vehicle body. According to such an example, by avoiding contact with the protruding portion 71 by using the recessed portion 28, the pressure vessel 10 is able to be housed by also using the space B of the underfloor space A. In other words, the pressure vessel 10 is able to be made larger and have a larger volume while effectively utilizing the limited underfloor space A of the vehicle. Although only one main body portion 20 is shown in FIG. 5, it may be understood that a plurality of main body portions 20 disposed side by side in the X direction each include the recessed portion 28 in accordance with the length of the protruding portion 71 in the X direction. Since the main body portions 20 are manufactured individually before being connected to the connecting portion 30, it is possible to easily provide each main body portion 20 with an uneven shape that matches the shape of the vehicle body.

In the pressure vessel 10 of the present embodiment, the presence of the liner is not essential. For example, the configuration of the pressure vessel 10 need not include the liner, at least in the configuration after the manufacturing. Further, the pressure vessel 10 may be manufactured using a method that does not use the liner.

Although specific examples of the technique disclosed in the present specification have been described in detail above, the examples are merely examples and do not limit the scope of claims. The technique described in the claims includes various modifications and variations of the specific examples exemplified above. Further, the technical elements described in the present specification or in the drawings exhibit technical usefulness alone or in various combinations, and are not limited to the combinations described in the claims at the time of filing the application. In addition, the technique exemplified in the present specification or in the drawings achieves a plurality of purposes at the same time, and achieving one of the purposes itself has technical usefulness.

What is claimed is:
1. A pressure vessel that is able to store fluid, the pressure vessel comprising:
   a plurality of main body portions provided with a space inside; and
   a connecting portion to which one ends of each of the main body portions are connected respectively, and communicating with the main body portions to one another, wherein
   a cross section perpendicular to a longitudinal direction of the main body portion has a substantially quadrilateral shape.
2. The pressure vessel according to claim 1, wherein the main body portion includes a reinforcing member that connects a pair of opposing surfaces within the space.
3. The pressure vessel according to claim 2, wherein:
   the reinforcing member includes one or more wires extending in the longitudinal direction while suturing between the opposing surfaces;
   a base is provided at one end of the main body portion; and
   one end of the wire may be fixed at a position away from the base at the one end of the main body portion in which the base is provided.
4. The pressure vessel according to claim 1, wherein the main body portion has an uneven shape that follows a shape of a vehicle body that demarcates at least a portion of a space in which the pressure vessel is housed.

What is claimed is:

1. A pressure vessel that is able to store fluid, the pressure vessel comprising:
a plurality of main body portions provided with a space inside; and
a connecting portion to which one ends of each of the main body portions are connected respectively, and communicating with the main body portions to one another, wherein
a cross section perpendicular to a longitudinal direction of the main body portion has a substantially quadrilateral shape.

2. The pressure vessel according to claim 1, wherein the main body portion includes a reinforcing member that connects a pair of opposing surfaces within the space.

3. The pressure vessel according to claim 2, wherein:
the reinforcing member includes one or more wires extending in the longitudinal direction while suturing between the opposing surfaces;
a base is provided at one end of the main body portion; and
one end of the wire may be fixed at a position away from the base at the one end of the main body portion in which the base is provided.

4. The pressure vessel according to claim 1, wherein the main body portion has an uneven shape that follows a shape of a vehicle body that demarcates at least a portion of a space in which the pressure vessel is housed.
